(19) United States
(12) Patent Application Publication
(10) Pub. No.: US 2024/0193923 A1
(43) Pub. Date: Jun. 13, 2024

(54) METHOD OF TRAINING TARGET OBJECT DETECTION MODEL, METHOD OF DETECTING TARGET OBJECT, ELECTRONIC DEVICE AND STORAGE MEDIUM

(71) Applicant: BEIJING BAIDU NETCOM SCIENCE TECHNOLOGY CO., LTD., Beijing (CN)

(72) Inventors: Xiaodi WANG, Beijing (CN); Shumin HAN, Beijing (CN); Yuan FENG, Beijing (CN); Ying XIN, Beijing (CN); Yi GU, Beijing (CN); Bin ZHANG, Beijing (CN); Chao LI, Beijing (CN); Xiang LONG, Beijing (CN); Honghui ZHENG, Beijing (CN); Yan PENG, Beijing (CN); Zhuang JIA, Beijing (CN); Yunhao WANG, Beijing (CN)

(21) Appl. No.: 17/908,070

(22) PCT Filed: Jan. 29, 2022
(86) PCT No.: PCT/CN2022/075108

§ 371 Date: Aug. 30, 2022

(30) Foreign Application Priority Data
Apr. 28, 2021 (CN) 202110469553.1

(51) Int. Cl. G06V 10/778

(52) U.S. Cl. CPC G06V 10/778; G06V 2201/07

(57) ABSTRACT

A method of training a target object detection model includes: extracting a plurality of feature maps of a sample image according to a training parameter, fusing the plurality of feature maps to obtain at least one fused feature map, and obtaining an information of a target object based on the at least one fused feature map, by using the target object detection model; determining a loss of the target object detection model based on the information of the target object and a tag information of the sample image, and adjusting the training parameter according to the loss of the target object detection model. A method of detecting a target object and an apparatus are also provided.

### CROSS REFERENCE TO RELATED APPLICATION(S)

This application claims priority to Chinese Patent Application No. 202110469553.1, filed on Apr. 28, 2021, which is incorporated herein in its entirety by reference.

### TECHNICAL FIELD

The present disclosure relates to a field of artificial intelligence, in particular to computer vision and deep learning technologies, which may be applied to Intelligent Cloud and power grid patrol inspection scenarios, and more specifically, to a method and an apparatus of training a target object detection model and a method and an apparatus of detecting a target object.

### BACKGROUND

With the progress of deep learning technology, the applications of computer vision technology in industrial scenes are more and more diverse. As a basis of computer vision technology, target detection technology may solve the problem of time-consuming and labor-consuming in a traditional manual detection, and thus would be used widely in the future. However, when detecting physical defects of industrial facilities, the detection results are often inaccurate due to the various types of the defects, the size difference between the defects or the like.

### SUMMARY

The present disclosure provides a method and an apparatus of training a target object detection model, a method and an apparatus of detecting a target object, and a storage medium.

According to an aspect of the present disclosure, there is provided a method of training a target object detection model, which includes: for any sample image of a plurality of sample images,
extracting a plurality of feature maps of the sample image according to a training parameter, fusing the plurality of feature maps to obtain at least one fused feature map, and obtaining an information of a target object based on the at least one fused feature map, by using the target object detection model;
determining a loss of the target object detection model, based on the information of the target object and an information related to a label of the sample image; and
adjusting the training parameter according to the loss of the target object detection model.

According to another aspect of the present disclosure, there is provided a method of detecting a target object by using a target object detection model, including: extracting a plurality of feature maps of an image to be detected;
fusing the plurality of feature maps to obtain at least one fused feature map; and detecting a target object based on the at least one fused feature map, wherein the target object detection model is trained by the method according to any embodiment of the present disclosure.

According to another aspect of the present disclosure, there is provided an apparatus of training a target object detection model, including:
a target object information obtaining module configured to extract a plurality of feature maps of a sample image according to a training parameter, fuse the plurality of feature maps to obtain at least one fused feature map, and obtain an information of a target object based on the at least one fused feature map, by using the target object detection model;
a loss determining module configured to determine a loss of the target object detection model based on the information of the target object and an information related to a label of the sample image; and
a parameter adjusting module configured to adjust the training parameter according to the loss of the target object detection model.

According to another aspect of the present disclosure, there is provided an apparatus of detecting a target object by using a target object detection model, including:
a feature map extracting module configured to extract a plurality of feature maps of an image to be detected;
a feature map fusion module configured to fuse the plurality of feature maps to obtain at least one fused feature map; and
a target object detection module configured to detect a target object based on the at least one fused feature map,
wherein the target object detection model is trained by the method of any embodiment of the present disclosure.

According to another aspect of the present disclosure, there is provided an electronic device, including: at least one processor; and a memory, communicatively coupled with the at least one processor; wherein the memory stores instructions executable by the at least one processor, and the instructions, when executed by the at least one processor, cause the at least one processor to perform the method of the embodiment of the present disclosure.

According to another aspect of the present disclosure, there is provided a non-transitory computer readable storage medium storing computer instructions, wherein the computer instructions are configured to cause a computer to perform the method of the embodiment of the present disclosure.

According to another aspect of the present disclosure, there is provided a computer program product including a computer program, wherein the computer program, when executed by a processer, implements the method provided by the embodiments of the present disclosure.

It should be understood that the content described in this part is not intended to identify key or features of the embodiments of the present disclosure, nor is it intended to limit the scope of the present disclosure. Other features of the present disclosure will be readily understood by the following description.

### BRIEF DESCRIPTION OF THE DRAWINGS

The drawings are used to better understand the scheme and do not constitute a limitation of the present disclosure. Wherein:

FIG. 1 shows a flowchart of a method of training a target object detection model according to an exemplary embodiment of the present disclosure;

FIG. 2A shows a flowchart of an operation performed by a target object detection model in the training process according to the embodiment of the present disclosure;

FIG. 2B shows a structural block diagram of the target object detection model according to the embodiment of the present disclosure;

FIG. 2C shows a schematic diagram of a process of extracting a feature map and fusing the feature map by using the target object detection model according to the embodiment of the present disclosure;

FIG. 2D shows a schematic diagram of a process of obtaining an (i−1)th level fused feature map based on the i^{th} level fused feature map and the (i−1)th level fused feature map according to the embodiment of the present disclosure;

FIG. 3A shows a flowchart of an operation performed by a target object detection model in the training process according to another embodiment of the present disclosure;

FIG. 3B shows a structural block diagram of a target object detection model according to another embodiment of the present disclosure;

FIG. 3C shows a schematic diagram of a process of obtaining an (i−1)^{th} level fused feature map based on the i^{th} level fused feature map and the (i−1)th level feature map according to another embodiment of the present disclosure;

FIG. 3D shows a schematic diagram of a process of obtaining an (i−1)^{th} level fused feature map based on the i^{th} level fused feature map and the (i−1)th level feature map according to another embodiment of the present disclosure;

FIG. 4 shows a schematic diagram of performing an overlap-cut on the sample image according to an exemplary embodiment of the present disclosure;

FIG. 5 shows a schematic of a head part in a target object detection model according to an exemplary embodiment of the present disclosure;

FIG. 6 shows a flowchart of a method of detecting a target object by using the target object detection model according to an exemplary embodiment of the present disclosure;

FIG. 7 shows a block diagram of an apparatus of training a target object detection model according to an exemplary embodiment of the present disclosure;

FIG. 8 shows a block diagram of an apparatus of detecting a target object by using a target object detection model according to an exemplary embodiment of the present disclosure; and

FIG. 9 shows a block diagram of an electronic device of another embodiment of the present disclosure.

### DETAILED DESCRIPTION OF EMBODIMENTS

An exemplary embodiment of the present disclosure with reference to the accompanying drawings, wherein including various details of the embodiments of the present disclosure to facilitate understanding, which should be considered merely exemplary. Therefore, those of ordinary skilled in the art should recognize that various changes and modifications described herein without departing from the scope and spirit of the present disclosure. Similarly, for the sake of clarity and conciseness, descriptions of well-known functions and structures are omitted in the following description.

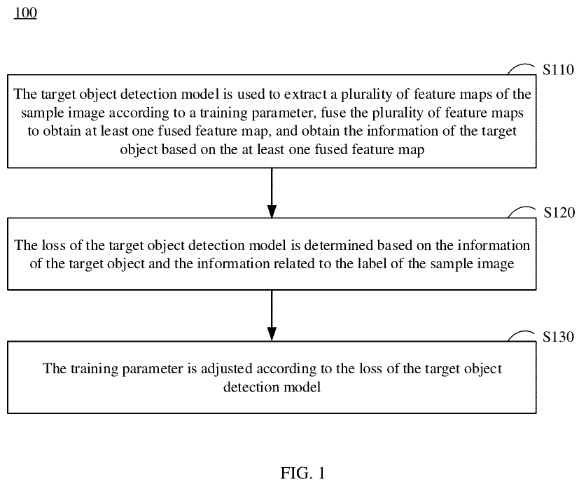

FIG. 1 shows a flowchart of a method of training a target object detection model according to an exemplary embodiment of the present disclosure.

Generally, the method of training the target object detection model may include: obtaining a plurality of sample images, and then training the model by using the plurality of sample images until a loss of the target object detection model reaches a training termination condition.

As shown in FIG. 1, the method 100 of training a target object detection model according to an exemplary embodiment of the present disclosure may specifically include performing steps S110 to S130 for any one of a plurality of sample images.

At step S110, the target object detection model is used to extract a plurality of feature maps of the sample image according to a training parameter, fuse the plurality of feature maps to obtain at least one fused feature map, and obtain the information of the target object based on the at least one fused feature map. The feature map is a representation of an image. The plurality of feature maps may be obtained through multiple convolution calculations.

After convolution kernel calculation, the feature map will become smaller and smaller. A high-level feature map has strong semantic information, while a low-level feature map has more location information. The present disclosure may obtain at least one fused feature map by fusing the plurality of feature maps. The fused feature map has both the semantic information and the location information. Therefore, in a case of detecting the target object by using the fused feature map, more accurate detecting may be achieved.

Through fusing the plurality of feature maps, a target object is detected by using the fused feature map, so as to obtain the information of the target object. The information of the target object may include a classification information of a detection box enclosing the target object, a center position coordinate of the target object and a scale information of the target object. In the exemplary embodiment of the present disclosure, the information of the target object further includes a segmentation region for the target object and a segmentation result for the target object.

At step S120, the loss of the target object detection model is determined based on the information of the target object and the information related to the label of the sample image. The loss of the target object detection model may include a calculation classification loss, a regression frame loss and a multi-branch loss, and so on. For example, each loss may be calculated by using respective loss function for calculating the loss, and the calculated losses may be summed to obtain the final calculated loss.

At step S130, the training parameter is adjusted according to the loss of the target object detection model. For example, it is determined whether the loss meets a training termination condition. The training termination condition may be set by a trainer according to the training needs. For example, it may be determined whether the training of the target object detection model has been completed according to a determination of whether the loss of the target object detection model converges and/or reaches a predetermined loss.

In response to determining that the loss reaches a training termination condition or reaches a predetermined loss, it is considered that the training of the target object detection model is completed and the method of training the target object detection model is ended. Otherwise, that is, when it is determined that the loss does not meet the training termination condition, the training parameter(s) may be adjusted according to the loss and the training is continued for the next training image in this training method.

In the exemplary embodiment of the present disclosure, by using the target object detection model to extract a plurality of feature maps of sample images and fuse the plurality of feature maps in the process of training, the trained target object detection model may obtain feature information which is more diverse, thereby improving the accuracy of target detection.

In some embodiment, before starting training, the plurality of sample images may be classified into a plurality of categories according to the labels of the sample images, and the target object detection model may be trained by using the sample images of each category respectively. For example, before performing the above step S110, the plurality of sample images may be classified into a plurality of categories according to the labels of the sample images, and steps S110 to S130 may be performed for the sample images of each category. In this way, classification training of the target object detection model may be achieved. When training the target object detection model for each category, the number of sample images of each category may be controlled, so as to achieve uniform sampling for labels belonging to different subcategories under the same category.

In an application of power grid defect detection, there is a great difference between the defects. If different defects are classified according to the size similarity of the defects to form different categories of labels, the defects under the same label category may further have multiple subcategories. For example, these subcategories may be divided according to the causes of the defects. The embodiments of the present disclosure may accelerate the convergence speed of training and improve the efficiency of training by using the above classification training method. When training the target object detection model for each label category, a data sampling strategy of dynamic sampling is performed for each subcategory, such that the difference between the number of trainings performed for a subcategory and the number of trainings performed for another subcategory would not be excessive, thereby further accelerating the training convergence speed and improving the accuracy of the training results.

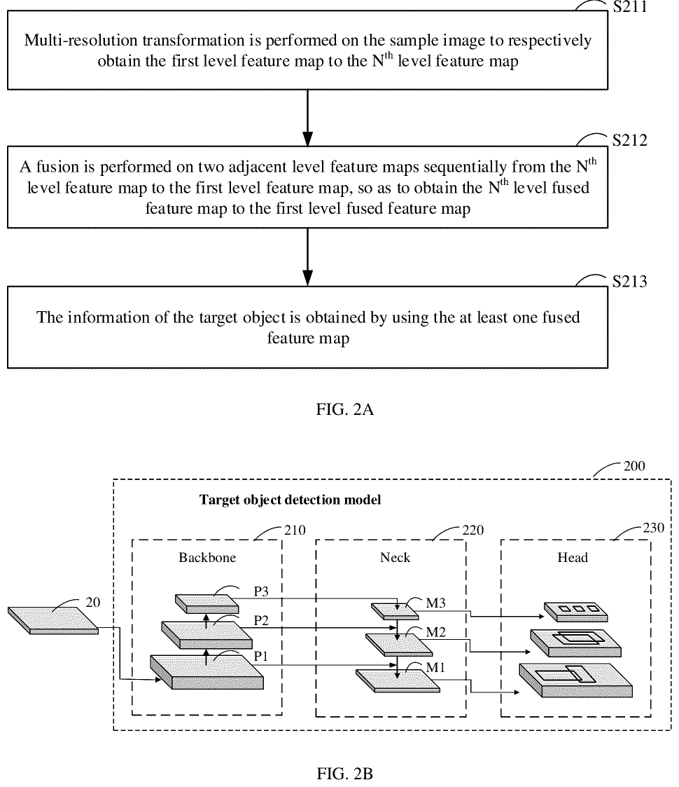

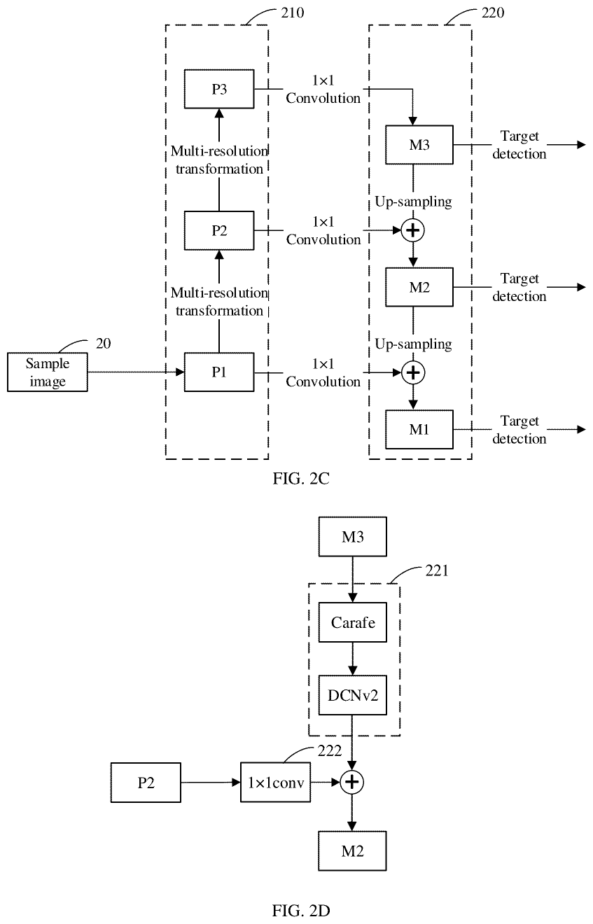

The operation performed by the target object detection model in the training process according to the exemplary embodiment of the present disclosure will be described below with reference to FIGS. 2A to 2D.

FIG. 2A shows a flowchart of an operation performed by a target object detection model in the training process according to the embodiment of the present disclosure. As shown in FIG. 2A, the above described operation of obtaining the information of the target object of the sample image by using the target object detection model may include steps S211 to S213.

At step S211, multi-resolution transformation is performed on the sample image to respectively obtain the first level feature map to the N^{th} level feature map, wherein n is an integer greater than or equal to 2. For example, convolution calculation may be performed on the sample image via a plurality of convolution layers (e.g. N convolution layers), with each convolution layer having a convolution kernel. Through the convolution calculation for the convolution kernel, N feature maps, i.e., the first level feature map to the N^{th} level feature map, may be obtained.

At step S212, a fusion is performed on two adjacent level feature maps sequentially from the N^{th} level feature map to the first level feature map, so as to obtain the N^{th} level fused feature map to the first level fused feature map. The high-level feature map has strong semantic information, while the low-level feature map has more position information. Therefore, through the fusion of the two adjacent level feature maps, the fused feature map used for target object detection may contain more diverse information, thereby improving the accuracy of detection.

At step S213, the information of the target object is obtained by using the at least one fused feature map. In the exemplary embodiment of the present disclosure, the information of the target object includes: a classification information of a detection box enclosing the target object, a coordinate of the central position of the target object, a scale information of the target object, a segmentation region and a segmentation result of the target object.

According to the embodiments of the present disclosure, by fusing a plurality of feature maps, which are obtained through multi-resolution transformation, according to the transformation level, the accuracy of detecting a multi-scale object may be improved without substantially increasing the amount of calculation. Accordingly, the embodiments of the present disclosure may be applied to a variety of scenes including complex scenes.

FIG. 2B shows a structural block diagram of the target object detection model according to the embodiment of the present disclosure. As shown in FIG. 2B, the target object detection model 200 may include a backbone part 210, a neck part 220, and a head part 230. The target object detection model 200 may be trained by using the sample image(s) 20. In the training process, the backbone part 210 is used to extract a plurality of feature maps, the neck part 220 is used to fuse the plurality of feature maps to obtain at least one fused feature map, and the head part 230 is used to detect the target object by using the at least one fused feature map to obtain the information of the target object.

The loss of the target object detection model may be determined based on the information of the target object and the information related to the labels of the sample images. For example, in the process of the target object detection model 200 performing the above operations, the information related to the calculation loss may be obtained from the backbone part 210, the neck part 220, and the head part 230. The loss of the target object detection model may be calculated based on the obtained information and the known information related to a label of the sample image by using respective loss calculation function(s). If the loss does not meet a preset convergence condition, the training parameter(s) used by the target object detection mode is adjusted, and then the training is performed again for the next sample image until the loss meets the preset convergence condition. In this way, the training of the target object detection model is achieved.

The backbone part 210, the neck part 220 and the head part 230 of the target object detection model will be described in detail hereafter.

The backbone part 210 may perform feature extraction for the sample image 20, for example, may generate a plurality of feature maps by using a convolutional neural network having preset training parameter(s). Specifically, the backbone part 210 may perform multi-resolution transformation on the sample image 20 to obtain the 1^{st} to N^{th} level feature maps P1, P2, . . . , PN, wherein N is an integer greater than or equal to 2. In FIG. 2B, the target object detection model 200 is illustrated by taking a 3 level resolution transform (N=3) as an example.

After the feature maps P1, P2, . . . , PN are extracted, if the target object detection model directly sends the feature maps P1, P2, . . . , PN extracted by the backbone part 210 to the head part 230 acting as a detection head to detect the target object, it would lack the ability of detecting a multi-scale target object. In contrast, according to the embodiment of the present disclosure feature maps in different stages may be collected by processing the first level feature map to the N^{th} level feature map, thereby enriching the information input to the head part 230.

The neck part 220 may fuse the first level feature map to the N^{th} level feature map. For example, the neck part 220 may, starting from the N^{th} level feature map, fuse two adjacent level feature maps of the N^{th} level feature map to the first level feature map, so as to obtain the N^{th} level fused feature map to the first level fused feature map MN, M (N−1), . . . , M1, where N=3 in FIG. 2B.

In one example, performing a fusion on two adjacent level feature maps sequentially from the N^{th} level feature map to the first level feature map may include: up-sampling an i^{th} level fused feature map to obtain an up-sampled i^{th} level fused feature map, wherein i is an integer and 2≤i≤N; performing 1×1 convolution on an (i−1)th level feature map, to obtain a convoluted (i−1)^{th} level feature map; and adding the convoluted (i−1)^{th} level feature map and the up-sampled i^{th} level fused feature map, to obtain an (i−1)^{th} level fused feature map, wherein the N^{th} level fused feature map is obtained by performing 1×1 convolution on the N^{th} level feature map.

The head part 230 may detect the target object by using at least one fused feature map to obtain the information of the target object. For example, the fused feature map MN, M(N−1), . . . , M1 are used to determine whether a preset category of target objects are contained in the sample image. The target objects may be for example but not limited to various defects that may exist in the power grid.

FIG. 2C shows a schematic diagram of a process of extracting a feature map and fusing the feature map by using the target object detection model according to the embodiment of the present disclosure. Referring to FIG. 2C, the backbone part 210 may performing multi-resolution transformation on the sample image 20 to obtain the first feature map P1, the second level feature map P2 and the third level feature map P3 respectively. Subsequently, two adjacent level feature maps of the first level feature map P1 to the third level feature map P3 are fused by the neck part 220, so as to obtain the third level fused feature map M3 to the first level fused feature map M1.

Specifically, in order to obtain other level feature maps other than the N^{th} level fused feature map, for example, in order to obtain the second level fused feature map M2, the third level fused feature map M3 may be up-sampled and 1×1 convolution may be performed on the second level feature map P2, and then the convoluted second level feature map and the up-sampled third level fused feature map are added to obtain the second level fused feature map, wherein the third level fused feature map M3 acting as the N^{th} level fused feature map is obtained by performing 1×1 convolution on the third feature map.

In one example, the fused feature map may be up-sampled by using an interpolation algorithm, that is, inserting new element(s) between the pixels on the basis of the existing pixels of the image by using a suitable interpolation algorithm. In addition, it is also possible to up-sample the i^{th} level fused feature map by applying the Carafe operator and a deformable convolution net (DCN) up-sampling operation to the i^{th} level fused feature map. Carafe (Content-Aware ReAssembly of Features) is an up-sampling method which may aggregate context information in a large perceptual field. Therefore, compared with the traditional interpolation algorithm, context information may be aggregated in higher accuracy in the feature map obtained by using the Carafe operator and the DCN up-sampling operation.

FIG. 2D shows a schematic diagram of a process of obtaining an (i−1)^{th} level fused feature map based on the i^{th} level fused feature map and the (i−1)^{th} level fused feature map according to the embodiment of the present disclosure. As shown in FIG. 2D, taking i=3 as an example, the third level fused feature map M3 may be up-sampled by the up-sampling module 221 including the Carafe operator and the DCNv2 operator in order to obtain an up-sampled third level fused feature map, wherein DCNv2 is a common operator in the DCN family. It is also possible to use other deformable convolution operators besides the DCNv2 operator. In addition, the second level feature map P2 is convoluted by the convolution module 222 to obtain a convoluted second level feature map. By summing the convoluted second level feature map and the up-sampled third level fused feature map, the second level fused feature map M2 is obtained.

According to the embodiments of the present disclosure, the (i−1)^{th} level fused feature map is obtained by adding the convoluted (i−1)^{th} level feature map and the up-sampled i^{th} level fused feature map, so that the fused feature map may reflect features having different resolutions and different semantic strengths, thereby further improving the accuracy of object detection.

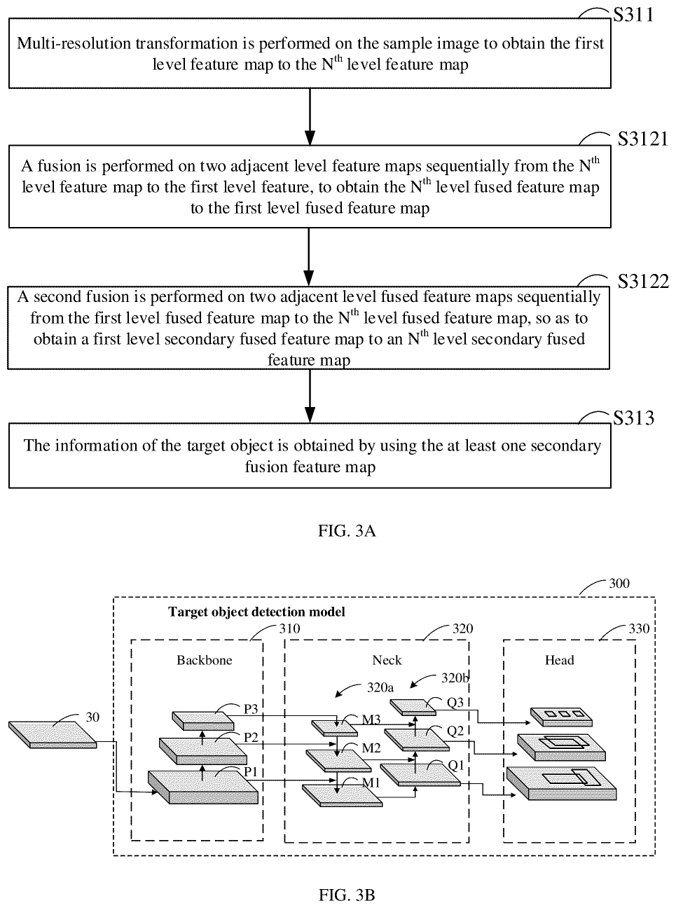

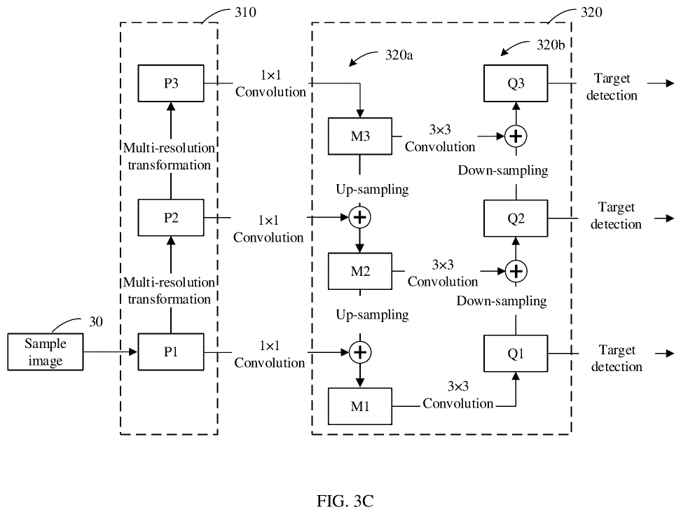

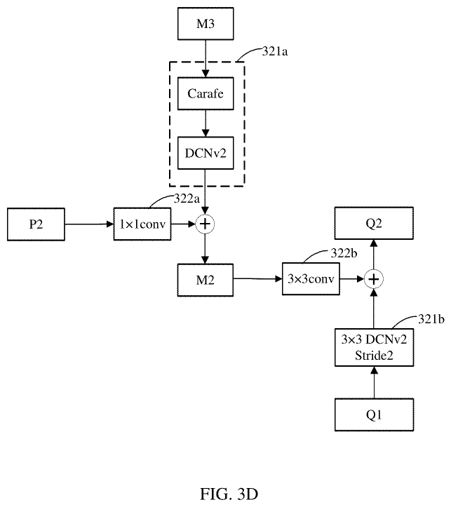

The operations performed by the target object detection model in the training process according to another embodiment of the present disclosure will be described below with reference to FIGS. 3A to 3D.

FIG. 3A shows a flowchart of an operation performed by a target object detection model in the training process according to another embodiment of the present disclosure.

As shown in FIG. 3A, the operation of obtaining the information of the target object of the sample image by using the target object detection model may include steps S311 to S313.

At step S311, multi-resolution transformation is performed on the sample image to obtain the first level feature map to the N^{th} level feature map. The first feature map to the N^{th} level feature map may be obtained by performing a convolution calculation on the sample image via N convolutional layers.

At step S3121, a fusion is performed on two adjacent level feature maps sequentially from the N^{th} level feature map to the first level feature, to obtain the N^{th} level fused feature map to the first level fused feature map. In this way, the fused feature map to be used for target object detection contains more diverse information.

It should be noted that steps S311 and S3121 may be the same as the above-mentioned steps S211 and S212 respectively, and thus will not be repeated here. Step S3122 will be described in detail below.

At step S3122, after the first fused feature maps to the N^{th} fused feature maps M1, M2, . . . , MN are extracted, a second fusion is performed on two adjacent level fused feature maps sequentially from the first level fused feature map to the N^{th} level fused feature map, so as to obtain a first level secondary fused feature map to an N^{th} level secondary fused feature map Q1, Q2, . . . , QN. In this way, the fused feature map at the top layer may benefit from the rich location information brought by the bottom layer, thereby improving the detection effect for large objects.

At step S313, the information of the target object is obtained by using the at least one secondary fusion feature map. Step S313 may be the same as the above-mentioned S213, and thus will not be repeated here.

In the embodiment of the present disclosure, by performing two fusions on the feature maps, the feature map at the top layer may contain the position information of the bottom layer, thereby improving the detection accuracy of the target object.

FIG. 3B shows a structural block diagram of a target object detection model according to another embodiment of the present disclosure. The target object detection model 300 shown in FIG. 3B is similar to the above-mentioned target object detection model 200, except that the target object detection model 300 performs two fusions on the first level feature map to the N^{th} level feature map P1, P2, . . . , PN. In order to simplify the description, only the differences between the target object detection model 300 and the target object detection model 200 will be described in detail below.

As shown in FIG. 3B, the target object detection model 300 includes a backbone part 310, a neck part 320, and a head part 330. The backbone part 310 and the head part 330 may be the same as the aforementioned backbone part 210 and the head part 230 respectively and thus will not be repeated here.

The neck part 320 includes a first fusion branch 320a and a second fusion branch 320b. The first fusion branch 320a may be used to obtain the N^{th} level fused feature map to the first level fused feature map. The second fusion branch 320b is configured to perform a second fusion on two adjacent level fused feature maps, sequentially from the first level fused feature map to the N^{th} level fused feature map, so as to obtain a first level secondary fused feature map to an N^{th} level secondary fused feature map Q1, Q2, . . . , QN.

FIG. 3C shows a schematic diagram of a process of obtaining an (i−1)^{th} level fused feature map based on the i^{th} level fused feature map and the (i−1)^{th} level feature map according to another embodiment of the present disclosure. As shown in FIG. 3C, the fusion of a plurality of feature maps P1, P2 and P3 is performed by the first fusion branch 320a including the up-sampling module 321a and the convolution module 222 to obtain the fused feature maps M1, M2 and M3. The second fusion branch 320b performs the fusion of the plurality of feature maps P1, P2 and P3 to obtain the secondary feature maps Q1, Q2 and Q3. Performing the second fusion may include the following steps. After the N^{th} level fused feature map to the first level fused feature map are obtained by the first fusion branch 320a, in order to obtain the (j+1)^{th} level secondary fused feature map Q(j+1) (j is an integer and 1≤j<N), the j^{th} level secondary fused feature map Qj is down-sampled and 3×3 convolution is performed on the (j+1)^{th} level fused feature map. Then the convoluted (j+1)^{th} fused feature map and the down-sampled j^{th} secondary fused feature map are added to obtain the (j+1)^{th} level secondary fused feature map Q(j+1), wherein the first level secondary feature map Q1 is obtained by performing 3×3 convolution on the first level fused feature map.

Specifically, in order to obtain other level secondary fused feature maps, for example, the second level secondary fused feature map Q2, except the first level secondary fused feature map, the first level secondary fused feature map Q1 is down-sampled, 3×3 convolution is performed on the second fused feature map M2, and then the convoluted second level fused feature map and the down-sampled third level secondary fused feature map are added, so that the second level secondary fused feature map Q2 is obtained. The first secondary fused feature map Q1 is obtained by performing 3×3 convolution on the first fused feature map M1, as shown in FIG. 3C.

In one example, the down-sampling of the secondary fused feature map may be performed by using a pooling operation. In addition, it is also possible to down-sample the j^{th} level secondary fused feature map by applying a deformable convolution DCN down-sampling operation to the j^{th} secondary fused feature map.

FIG. 3D shows a schematic diagram of a process of obtaining an (i−1)^{th} level fused feature map based on the i^{th} level fused feature map and the (i−1)^{th} level feature map according to another embodiment of the present disclosure. As shown in FIG. 3D, in order to obtain the second level secondary fused feature map Q2, the first level secondary fused feature map Q1 is down-sampled by the down-sampling module 321b implemented as 3×3DCNv2 Stride2 to obtain a down-sampled first level secondary fused feature map. In addition, the second level fused feature map M2 is convoluted by the convolution module 322b to obtain a convoluted second level fused feature map. Finally, the second level secondary fused feature map Q2 is obtained by summing the convoluted second level fused feature map and the down-sampled first level secondary fused feature map.

In the embodiment of the present disclosure, by performing two fusions on the feature maps, the feature map of the top layer may contain the position information of the bottom layer, thereby improving the detection accuracy of the target object.

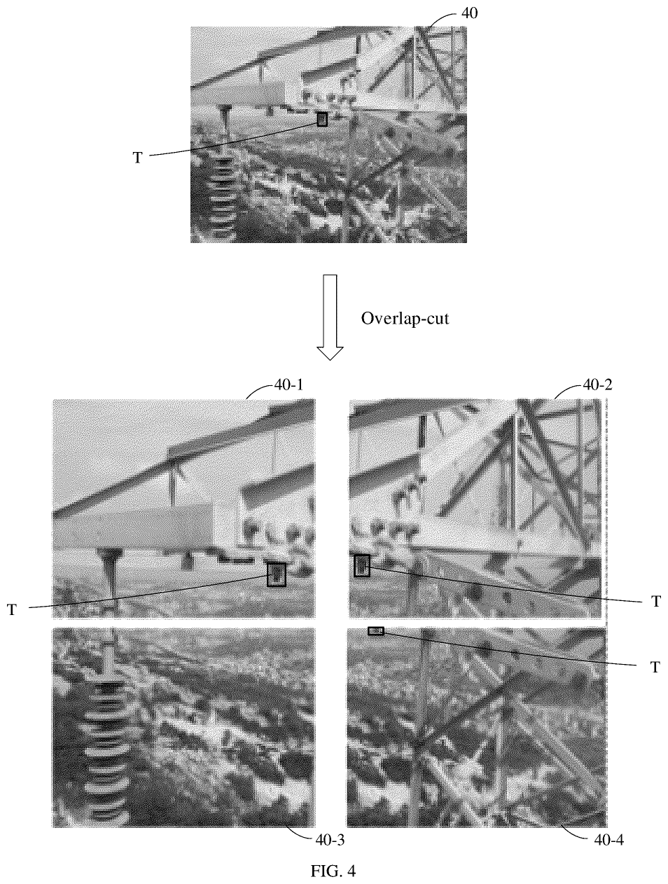

In some embodiments, the sample image may be additionally preprocessed before performing feature extraction on the sample image. For example, before extracting the feature map of the sample image, overlap-cut may be performed on the sample image to obtain at least two cut images, wherein any two of at least two cut images have an overlapping image region between them. FIG. 4 shows a schematic diagram of overlap-cut of the sample image according to an exemplary embodiment of the present disclosure.

As shown in FIG. 4, in application scenarios such as unmanned aerial vehicles and remote sensing, small-sized target objects would be failed to be detected or recognized if the size of the captured sample image is too large. For example, the target object T in the sample image 40 occupies a relatively small proportion in the entire image, and thus is difficult to be detected. According to the embodiment of the present disclosure, overlap-cut may be performed on the sample image 40 to obtain four cut images 40-1 to 40-4. There are overlapping image regions between edges of the cut images 40-1 to 40-4. Accordingly, the target object T may appear in a plurality of cut images, for example in cut images 40-1, 40-2 and 40-4. The target object T occupies a larger proportion in the cut images 40-1, 40-2 and 40-4 than that in the sample image 40. The target object detection model may be trained by using the cut images 40-1 to 40-4, thereby further improving the detection ability of a target object training model for small target objects.

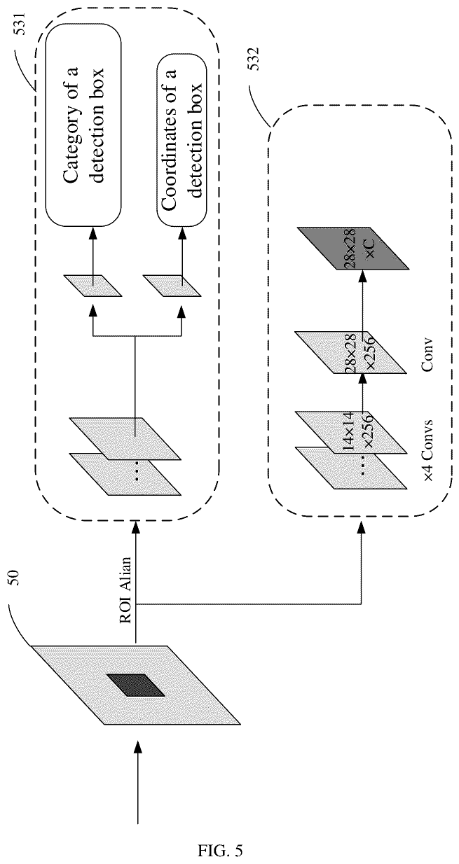

In addition, in order to increase the detection capability, another branch may further be added into the head part of the target object detection model of any embodiment as described above, so as to detect the segmentation information for the target object. FIG. 5 shows a schematic of a head part in a target object detection model according to an exemplary embodiment of the present disclosure.

As shown in FIG. 5, the fused feature map 50 (e.g., the fused feature map Mi or the secondary fused feature map Qi) is input to the head part which may include two branches 531 and 532. The branch 531 is a branch used to detect a coordinate of a detection box enclosing the target object and a classification category of the detection box, and the branch 532 is used to output a segmentation region and a segmentation result for the target object. The branch 532 is a branch including 5 convolution layers and a prediction layer, which outputs images containing segmentation information. The 5 convolution layers include four 14×14×256 convolution layers (14×14×256 Convs) and one 28×28×256 convolution layer (28×28×256 Conv). That is, the feature map processed as above is input into the head part including two detection branches to detect the target object. One of the two detection branches outputs a coordinate of the detection box enclosing the target object and a classification category of the detection box, and the other of the two detection branches outputs a segmentation region and a segmentation result for the target object.

In this way, more information of the target object may be output, and the output segmentation information may be used to supervise the learning of the network parameters. Accordingly, the accuracy of target detection of each branch is improved, such that defects having various shapes may be localized and recognized by using the segmentation regions directly.

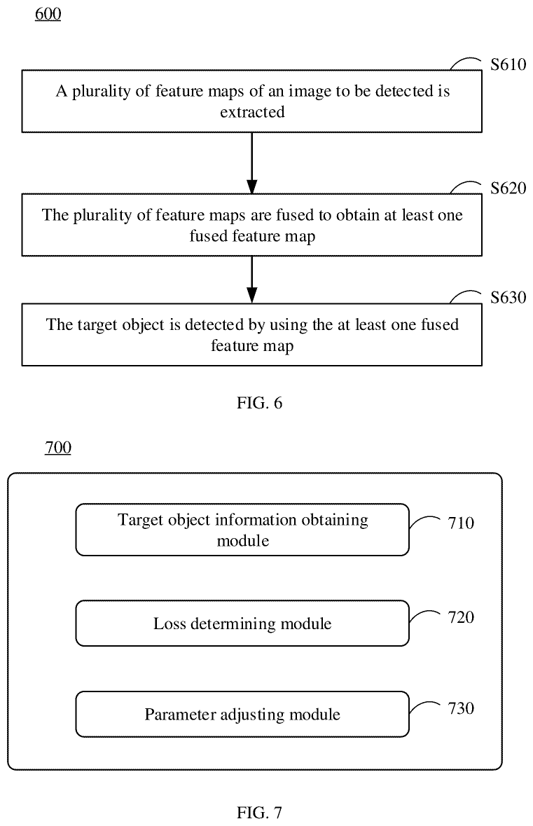

According to another aspect of the present disclosure, a method of detecting a target object is also provided. FIG. 6 shows a flowchart of a method of detecting a target object by using the target object detection model according to an exemplary embodiment of the present disclosure.

At step S610, a plurality of feature maps of an image to be detected is extracted by using the target object detection model. The target object detection model may be a target object detection model trained by the training method of the embodiments as described above. The target object detection model may have the neutral network structure as described in any of the above embodiments. The image to be detected may be an image captured by a drone. In addition, when the method of detecting a target object according to an exemplary embodiment of the present disclosure is used to detect a defect of a power grid, the image to be detected is an image related to the defect of the power grid. The process of extracting the plurality of feature maps of the image to be detected by using the target object detection model may be the same as the process of extracting features in the training method as described above, and thus will not be repeated here.

At step S620, the plurality of feature maps may be fused by the target object detection model to obtain at least one fused feature map, so as to obtain fused feature map(s) containing more diverse information about the target object. The process of fusing the plurality of feature maps by using target object detection model may be the same as the process of fusing in the training method as described above, and thus will not be repeated here.

At step S630, the target object is detected by the target object detection model based on at least one fused feature map. The process of detecting the target object by using the target object detection model may be the same as the process of fusing in the training method as described above, and thus will not repeated here.

In addition, when detecting the target object by using the target object detection model trained according to the exemplary embodiment of the present disclosure, the image to be detected may further be preprocessed. The preprocessing includes but is not limited to up-sampling the image to be detected to double the size of the original image, and then sending the image to the target object detection model to detect the target object.

According to the embodiments of the present disclosure, through extracting a plurality of feature maps of an image to be detected by using a target object detection model and fusing the plurality of feature maps, more diverse feature information may be obtained, thereby improving the accuracy of target detection.

FIG. 7 shows a block diagram of a device of training a target object detection model according to an exemplary embodiment of the present disclosure.

As shown in FIG. 7, the device 700 may include a target object information obtaining module 710, a loss determination module 720 and a parameter adjusting module 730.

The target object information obtaining module 710 may be configured to extract a plurality of feature maps of a sample image according to a training parameter, fuse the plurality of feature maps to obtain at least one fused feature map, and obtain information of the target object by using the at least one fused feature map, by using the target object detection model. In the exemplary embodiment of the present disclosure, the information of the target object includes a classification information of a detection box enclosing the target object, a coordinate of a center position of the target object, a scale information of the target object, a segmentation region for the target object and a segmentation result for the target object.

The loss determination module 720 may be configured to determine a loss of the target object detection model based on the information of the target object and the information related to a label of the sample image. The loss of the target object detection model may include a calculation classification loss, a regression frame loss and a multi-branch loss. For example, each of the losses may be calculated by a respective existing loss function for calculating the loss, and the calculated loss values may be summed to obtain the loss of the target object detection model.

The parameter adjusting module 730 may be configured to adjust the training parameter according to the loss of the target object detection model. For example, it may be determined whether the loss meets a training termination condition. The training termination condition may be set as desired by a trainer. For example, the parameter adjusting module 730 may determine whether the training of the target object detection model is completed according to whether the loss of the target object detection model converges and/or reaches a predetermined value.

In the exemplary embodiment of the present disclosure, a plurality of feature maps of the sample image are extracted by using the target detection model and the plurality of feature maps are fused in the training, so that the trained target object detection model may obtain more diverse feature information, thereby improving the accuracy of the target object detection model.

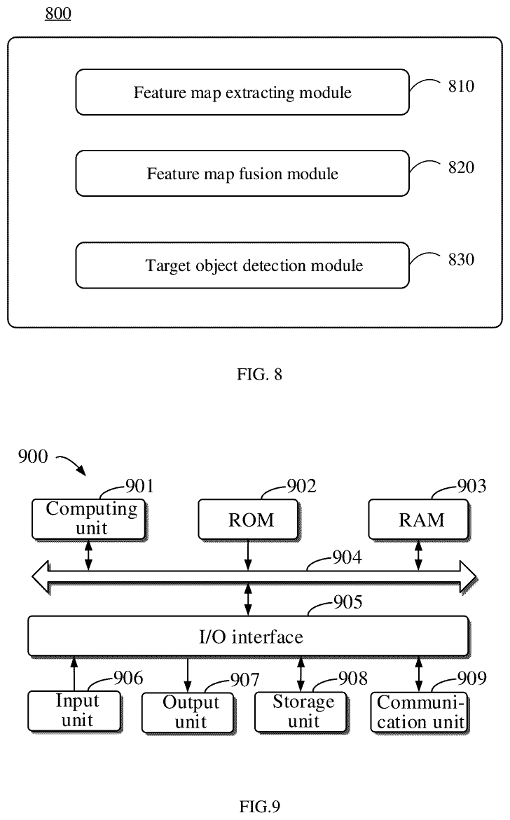

FIG. 8 shows a block diagram of an apparatus of detecting a target object by using a target object detection model according to an exemplary embodiment of the present disclosure.

As shown in FIG. 8, the apparatus 800 of detecting a target object may include a feature map extraction module 810, a feature map fusion module 820, and a target object detection module 830.

The feature map extraction module 810 may be configured to extract a plurality of feature maps of an image to be detected by using the target object detection model. The target object detection model may be trained according to the method and/or apparatus of training according to the exemplary embodiment of the present disclosure. The image to be detected may be an image obtained by an unmanned aerial vehicle. In addition, when the method of detecting a target object according to an exemplary embodiment of the present disclosure is used to detect a defect of a power grid, the image to be detected is an image related to the defect of the power grid.

The feature map fusion module 820 may be configured to fuse the plurality of feature maps by using the target object detection model to obtain at least one fused feature map.

The target object detection module 830 may be configured to detect the target object based on the at least one fused feature map by using the target object detection model.

According to the embodiments of the present disclosure, through extracting a plurality of feature maps of an image to be detected and fusing the plurality of feature maps by using the target object detection model, more diverse feature information may be obtained, thereby improving the accuracy of target detection.

In the technical scheme of the present disclosure, obtaining, storing and applying of the personal information of the user all comply with the relevant laws and regulations, and do not violate public order and morals.

According to the embodiments of the present disclosure, the present disclosure further provides an electronic device, a readable storage medium, and a computer program product. By extracting a plurality of feature maps of an image to be detected and fusing the plurality of feature maps, more diverse feature information may be obtained, thereby improving the accuracy of target detection.

FIG. 9 shows a block diagram of an electronic device of another embodiment of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 9, the electronic device 900 may include computing unit 901, which may perform various appropriate actions and processing based on a computer program stored in a read-only memory (ROM) 902 or a computer program loaded from a storage unit 908 into a random access memory (RAM) 903. Various programs and data required for the operation of the electronic device 900 may be stored in the RAM 903. The computing unit 901, the ROM 902 and the RAM 903 are connected to each other through a bus 904. An input/output (I/O) interface 905 is further connected to the bus 904.

I/O interface 905 are connected to various components in the electronic device 900, including an input unit 906, such as a keyboard, a mouse, etc.; an output unit 907, such as various types of displays, speakers, etc.; a storage unit 908, such as a magnetic disk, an optical disk, etc.; and a communication unit 909, such as a network card, a modem, a wireless communication transceiver, etc. The communication unit 909 allows the electronic device 900 to exchange information/data with other devices through a computer network such as the Internet and/or various telecommunication networks.

The computing unit 901 may be various general-purpose and/or special-purpose processing components with processing and computing capabilities. Some examples of the computing unit 901 include but are not limited to a central processing unit (CPU), a graphics processing unit (GPU), various dedicated artificial intelligence (AI) computing chips, various computing units running machine learning model algorithms, a digital signal processor (DSP), and any appropriate processor, controller, microcontroller, and so on. The computing unit 901 may perform the various methods and processes described above, such as the methods and processes shown in FIGS. 1 to 6. For example, in some embodiments, the methods and processes shown in FIGS. 1 to 6 may be implemented as a computer software program that is tangibly contained on a machine-readable medium, such as a storage unit 908. In some embodiments, part or all of a computer program may be loaded and/or installed on the electronic device 900 via the ROM 902 and/or the communication unit 909. When the computer program is loaded into the RAM 903 and executed by the computing unit 901, one or more steps of the method of training the target object detection model described above may be performed. Alternatively, in other embodiments, the computing unit 901 may be configured to perform the method of training the target object detection model in any other appropriate way (for example, by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from the storage system, the at least one input device and the at least one output device, and may transmit the data and instructions to the storage system, the at least one input device, and the at least one output device.

Program codes for implementing the method of the present disclosure may be written in any combination of one or more programming languages. These program codes may be provided to a processor or a controller of a general-purpose computer, a special-purpose computer, or other programmable data processing devices, so that when the program codes are executed by the processor or the controller, the functions/operations specified in the flowchart and/or block diagram may be implemented. The program codes may be executed completely on the machine, partly on the machine, partly on the machine and partly on the remote machine as an independent software package, or completely on the remote machine or server.

In the context of the present disclosure, the machine readable medium may be a tangible medium that may contain or store programs for use by or in combination with an instruction execution system, device or apparatus. The machine readable medium may be a machine-readable signal medium or a machine-readable storage medium. The machine readable medium may include, but not be limited to, electronic, magnetic, optical, electromagnetic, infrared or semiconductor systems, devices or apparatuses, or any suitable combination of the above. More specific examples of the machine readable storage medium may include electrical connections based on one or more wires, portable computer disks, hard disks, random access memory (RAM), read-only memory (ROM), erasable programmable read-only memory (EPROM or flash memory), optical fiber, convenient compact disk read-only memory (CD-ROM), optical storage device, magnetic storage device, or any suitable combination of the above.

In order to provide interaction with users, the systems and techniques described here may be implemented on a computer including a display device (for example, a CRT (cathode ray tube) or LCD (liquid crystal display) monitor) for displaying information to the user, and a keyboard and a pointing device (for example, a mouse or a trackball) through which the user may provide the input to the computer. Other types of devices may also be used to provide interaction with users. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and Internet.

The computer system may include a client and a server. The client and the server are generally far away from each other and usually interact through a communication network. The relationship between the client and the server is generated through computer programs running on the corresponding computers and having a client-server relationship with each other. The server may be a cloud server, also referred to as a cloud computing server. The server may also be a server of a distributed system, or a server combined with a block-chain.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

1. A method of training a target object detection model, the method comprising: for any sample image of a plurality of sample images,
extracting a plurality of feature maps of the sample image according to a training parameter, fusing the plurality of feature maps to obtain at least one fused feature map, and obtaining an information of a target object based on the at least one fused feature map, by using the target object detection model;
determining a loss of the target object detection model, based on the information of the target object and an information related to a label of the sample image; and
adjusting the training parameter according to the loss of the target object detection model.

2. The method of claim 1, wherein the extracting a plurality of feature maps of the sample image comprises performing a multi-resolution transformation to the sample image, so as to obtain a first level feature map to an N^{th} level feature map respectively, wherein N is an integer greater than or equal to 2; and
wherein the fusing the plurality of feature maps comprises performing a fusion on two adjacent level feature maps sequentially from the N^{th} level feature map to the first level feature map, so as to obtain a N^{th} level fused feature map to the first level fused feature map.

3. The method of claim 2, wherein the performing a fusion on two adjacent level feature maps sequentially from the N^{th} level feature map to the first level feature map comprises:
up-sampling an i^{th} level fused feature map to obtain an up-sampled i^{th} level fused feature map, wherein i is an integer and 2≤i≤N;
performing a 1×1 convolution on an (i−1)^{th} level feature map, to obtain a convoluted (i−1)^{th} level feature map; and
adding the convoluted (i−1)^{th} level feature map and the up-sampled i^{th} level fused feature map, to obtain an (i−1)^{th} level fused feature map,
wherein the N^{th} level fused feature map is obtained by performing the 1×1 convolution on the N^{th} level feature map.

4. The method of claim 3, wherein the up-sampling the i^{th} level fused feature map comprises up-sampling the i^{th} level fused feature map by applying a Carafe operator and a deformable convolution net (DCN) up-sampling operation to the i^{th} level fused feature map.

5. The method of claim 2, wherein after obtaining the N^{th} level fused feature map to the first level fused feature map, the method further comprises performing a second fusion on two adjacent level fused feature maps sequentially from the first level fused feature map to the N^{th} level fused feature map, so as to obtain a first level secondary fused feature map to an N^{th} level secondary fused feature map.

6. The method of claim 5, wherein the performing a second fusion comprises:
down-sampling a j^{th} level secondary fused feature map, to obtain a down-sampled j^{th} level secondary fused feature map, wherein j is an integer and 1≤j<N;
performing a 3×3 convolution on a (j+1)^{th} level fused feature map, so as to obtain a convoluted (j+1)^{th} level fused feature map; and
adding the convoluted (j+1)^{th} level fused feature map and the down-sampled j^{th} level secondary fused feature map, so as to obtain a (j+1)^{th} level secondary fused feature map,
wherein the first level secondary fused feature map is obtained by performing a 3×3 convolution on the first level fused feature map.

7. The method of claim 6, wherein the down-sampling a j^{th} level secondary fused feature map comprises down-sampling the j^{th} level secondary fused feature map by performing a deformable convolution net (DCN) down-sampling operation on the j^{th} level secondary fused feature map.

8. The method of claim 1, further comprising, before extracting the plurality of feature maps of the sample image, performing an overlap-cut on the sample image to obtain at least two cut images, wherein one of any two cut images of the at least two cut images has an image region overlapping with an image region of the other one of any two images of the at least two cut images.

9. The method of claim 1, wherein the obtaining an information of a target object based on the at least one fused feature map comprises detecting the target object by inputting the at least one fused feature map into two detection branches, so as to obtain the information of the target object,
wherein one of the two detection branches outputs a coordinate of a detection box enclosing the target object and a classification category of the detection box, and the other one of the two detection branches outputs a segmentation region for the target object and a segmentation result for the target object.

10. The method of claim 1, further comprising, before extracting, by using the target object detection model, a plurality of feature maps of the sample image according to a training parameter, the plurality of sample images are classified into a plurality of categories according to labels of sample images, and
wherein the extracting, by using the target object detection model, a plurality of feature maps of the sample image according to a training parameter is performed for each category of the plurality of categories of sample images.

11. A method of detecting a target object, the method comprising: by using a target object detection model,
extracting a plurality of feature maps of an image to be detected;
fusing the plurality of feature maps to obtain at least one fused feature map; and
detecting a target object based on the at least one fused feature map,
wherein the target object detection model is trained by the method of claim 1.

12. The method of claim 11, wherein the image to be detected is an image captured by an unmanned aerial vehicle.

13. The method of claim 11, wherein the image to be detected is an image related to a defect of a power grid.

14.-15. (canceled)

16. An electronic device, comprising:
at least one processor; and
a memory, communicatively coupled with the at least one processor, wherein the memory stores instructions executable by the at least one processor, and the instructions, when executed by the at least one processor, cause the at least one processor to at least perform the method of claim 1.

17. A non-transitory computer readable storage medium storing computer instructions, wherein the computer instructions are configured to cause a computer system to at least perform the method of claim 1.

18. (canceled)

19. The method of claim 12, wherein the image to be detected is an image related to a defect of a power grid.

20. The electronic device of claim 16, wherein the instructions are further configured to cause the at least one processer to:
perform a multi-resolution transformation to the sample image, so as to obtain a first level feature map to an N^{th} level feature map respectively, wherein N is an integer greater than or equal to 2; and
perform a fusion on two adjacent level feature maps sequentially from the N^{th} level feature map to the first level feature map, so as to obtain a N^{th} level fused feature map to the first level fused feature map.

21. The electronic device of claim 20, wherein the instructions are further configured to cause the at least one processer to:
up-sample an i^{th} level fused feature map to obtain an up-sampled i^{th} level fused feature map, wherein i is an integer and 2≤i≤N;
perform 1×1 convolution on an (i−1)^{th} level feature map, to obtain a convoluted (i−1)^{th} level feature map; and
add the convoluted (i−1)^{th} level feature map and the up-sampled i^{th} level fused feature map, to obtain an (i−1)^{th} level fused feature map,
wherein the N^{th} level fused feature map is obtained by performing 1×1 convolution on the N^{th} level feature map.

22. An electronic device, comprising:
at least one processor; and
a memory, communicatively coupled with the at least one processor, wherein the memory stores instructions executable by the at least one processor, and the instructions, when executed by the at least one processor, cause the at least one processor to perform the method of claim 11.

23. A non-transitory computer readable storage medium storing computer instructions, wherein the computer instructions are configured to cause a computer system to perform the method of claim 11.
